(19) United States
(12) Patent Application Publication
(10) Pub. No.: US 2020/0008178 A1
(43) Pub. Date: Jan. 2, 2020

(54) Wireless Communication Method and Device

(71) Applicant: Guangdong OPPO Mobile Telecommunications Corp., Ltd., Dongguan, Guangdong (CN)

(72) Inventors: Zhi Zhang, Dongguan, Guangdong (CN); Hai Tang, Dongguan, Guangdong (CN)

(21) Appl. No.: 16/493,291

(22) PCT Filed: Mar. 23, 2017
(86) PCT No.: PCT/CN2017/077940

§ 371 Date: Sep. 11, 2019

(51) Int. Cl. H04W 72/02; H04L 5/00; H04W 72/04

(52) U.S. Cl. CPC H04W 72/02; H04W 72/0453; H04W 72/0446; H04L 5/005

(57) ABSTRACT

A wireless communication method and device are provided. The method includes: a network device determines N target frequency domain units for sending reference signals and a target reference signal pattern of each target frequency domain unit in the N target frequency domain units, wherein N is an integer greater than or equal to 1; and the network device sends the reference signals on the each target frequency domain unit according to the target reference signal pattern.

### CROSS-REFERENCE TO RELATED APPLICATION(S)

This application is a 371 application of International Application No. PCT/CN2017/077940, filed on Mar. 23, 2017, the entire disclosure of which is hereby incorporated by reference.

### TECHNICAL FIELD

The present application relates to the field of communications, and more particularly, to a wireless communication method and device.

### BACKGROUND

In a Long Term Evolution (LTE) system, a terminal device can realize a fine synchronization on time-frequency domain based on a Cell-Specific Reference Signal (CRS).

The CRS has characteristics of being sent on a full bandwidth, having a relatively high density in the time-frequency domain and being sent periodically, which results in waste of resources and low flexibility.

However, in a 5th generation (5G) system, resource utilization and flexibility are required to be high, thus the sending of the existing CRS cannot meet requirements of the 5G system.

### SUMMARY

Implementations of the application provide a wireless communication method and device.

In a first aspect, a wireless communication method is provided. The method includes: a network device determines N target frequency domain units for sending reference signals and a target reference signal pattern of each target frequency domain unit in the N target frequency domain units, wherein N is an integer greater than or equal to 1; and the network device sends the reference signals on the each target frequency domain unit according to the target reference signal pattern.

In combination with the first aspect, in a possible implementation of the first aspect, determining, by the network device, the N target frequency domain units for sending the reference signals and the target reference signal pattern of the each target frequency domain unit in the N target frequency domain units, includes: the network device determines the N target frequency domain units from at least one frequency domain unit available in a system.

In combination with the first aspect or any one of the above possible implementations thereof, in a possible implementation of the first aspect, determining, by the network device, the N target frequency domain units from the at least one frequency domain unit available in the system, includes: the network device determines a quantity N of the target frequency domain units for sending the reference signals according to at least one of a quantity of terminal devices currently located in the system, a load condition of the system and a service condition of each terminal device in the system; and the network device determines the N target frequency domain units from the at least one frequency domain unit.

In combination with the first aspect or any one of the above possible implementations thereof, in a possible implementation of the first aspect, the method further includes: the network device sends a first message, wherein the first message is used for indicating at least one of:

a quantity of frequency domain units available in the system;

a sub-band occupied by each frequency domain unit;

a quantity N of the target frequency domain units; and

a sub-band occupied by each target frequency domain unit.

In combination with the first aspect or any one of the above possible implementations thereof, in a possible implementation of the first aspect, before the network device sends the reference signals on the each target frequency domain unit according to the target reference signal pattern, the method further includes: the Network device schedules a terminal device in a system to the N target frequency domain units.

In combination with the first aspect or any one of the above possible implementations thereof, in a possible implementation of the first aspect, the method further includes: the network device determines that a quantity of the target frequency domain units for sending the reference signals needs to be changed from N to M, wherein M is a positive integer that is not equal to N; the network device determines M target frequency domain units for sending the reference signals; and the network device sends the reference signals on the M target frequency domain units.

In combination with the first aspect or any one of the above possible implementations thereof, in a possible implementation of the first aspect, N is greater than M, and the N target frequency domain units include the M target frequency domain units, and the method further includes: the network device sends a second message, wherein the second message is used for indicating that frequency domain units for sending the reference signals are the M target frequency domain units, or used for indicating frequency domain units on which sending of the reference signals is stopped in the N target frequency domain units.

In combination with the first aspect or any one of the above possible implementations thereof, in a possible implementation of the first aspect, N is smaller than M, and the method further includes: the network device sends a third message, wherein the third message is used for indicating that frequency domain units for sending the reference signals are the M target frequency domain units, or used for indicating M-N target frequency domain units newly added for sending the reference signals in the M target frequency domain units in addition to the N target frequency domain units.

In combination with the first aspect or any one of the above possible implementations thereof, in a possible implementation of the first aspect, determining, by the network device, that the quantity of the target frequency domain units for sending the reference signals needs to be changed from N to M, includes: the network device determines that the quantity of the target frequency domain units for sending the reference signals needs to be changed from N to M according to at least one of: a quantity of terminal devices currently located in a system, a load condition of a system and a service condition of each terminal device in a system.

In combination with the first aspect or any one of the above possible implementations thereof, in a possible implementation of the first aspect, determining, by the network device, the N target frequency domain units for sending the reference signals and the target reference signal pattern of the each target frequency domain unit in the N target frequency domain units, includes: the network device selects a target reference signal pattern corresponding to a first target frequency domain unit in the N target frequency domain units from at least one basic reference signal pattern available in a system, to send the reference signals on the first target frequency domain unit according to the target reference signal pattern corresponding to the first target frequency domain unit.

In combination with the first aspect or any one of the above possible implementations thereof, in a possible implementation of the first aspect, the method further includes: the network device sends a fourth message to a terminal device, wherein the fourth message is used for indicating at least one of:

a basic reference signal pattern is enabled on the first target frequency domain unit; a quantity of basic reference signal patterns available in the system;

positions and/or density of reference signals included in basic reference signal patterns available in the system;

a corresponding relationship between basic reference signal patterns available in the system and frequency domain units available in the system; and

information of the target reference signal pattern corresponding to the first target frequency domain unit.

In combination with the first aspect or any one of the above possible implementations thereof, in a possible implementation of the first aspect, the method further includes: the network device determines that the target reference signal pattern corresponding to the first target frequency domain unit needs to be changed; the network device determines a changed target reference signal pattern corresponding to the first target frequency domain unit; and the network device sends the reference signals on the first target frequency domain unit according to the changed target reference signal pattern.

In combination with the first aspect or any one of the above possible implementations thereof, in a possible implementation of the first aspect, determining, by the network device, that the target reference signal pattern corresponding to the first target frequency domain unit needs to be changed, includes: the network device determines that the target reference signal pattern corresponding to the first target frequency domain unit needs to be changed according to data currently transmitted and/or a time-frequency resource occupied by data.

In combination with the first aspect or any one of the above possible implementations thereof, in a possible implementation of the first aspect, the method further includes: the network device determines a time domain unit, on which the target reference signal pattern needs to be changed, on the first target frequency domain unit, in order to send the reference signals on the time domain unit according to the changed target reference signal pattern.

In combination with the first aspect or any one of the above possible implementations thereof, in a possible implementation of the first aspect, determining the changed target reference signal pattern corresponding to the first target frequency domain unit includes: determining a first additional reference signal pattern; and determining the changed target reference signal pattern according to the target reference signal pattern before the change and the first additional reference signal pattern.

In combination with the first aspect or any one of the above possible implementations thereof, in a possible implementation of the first aspect, determining the first additional reference signal pattern includes: performing time domain offset and/or frequency domain offset on at least one position of the reference signals of the target reference signal pattern before the change corresponding to the first target frequency domain unit to obtain the first additional reference signal pattern.

In combination with the first aspect or any one of the above possible implementations thereof, in a possible implementation of the first aspect, determining the first additional reference signal pattern includes: performing time domain offset and/or frequency domain offset on at least one position of the reference signals of at least one pattern in patterns except the basic reference signal pattern to obtain the first additional reference signal pattern.

In combination with the first aspect or any one of the above possible implementations thereof, in a possible implementation of the first aspect, determining the first additional reference signal pattern includes: determining the first additional reference signal pattern from multiple additional reference signal patterns.

In combination with the first aspect or any one of the above-mentioned possible implementations thereof, in a possible implementation of the first aspect, determining that the target reference signal pattern corresponding to the first target frequency domain unit needs to be changed includes: determining the target reference signal pattern corresponding to the first target frequency domain unit needs to be changed according to a first changing request sent by a terminal device on the first target frequency domain unit.

In combination with the first aspect or any one of the above possible implementations thereof, in a possible implementation of the first aspect, the first changing request is used for indicating at least one of:

increasing or decreasing density of reference signals of the target reference signal pattern corresponding to the first target frequency domain unit;

density and/or positions of reference signals of the changed target reference signal pattern corresponding to the first target frequency domain unit;

information of a changed basic reference signal pattern corresponding to the first target frequency domain unit;

time domain offset information and/or frequency domain offset information for performing offset on the target reference signal pattern before the change corresponding to the first target frequency domain unit;

information of an additional reference signal pattern requested to be added;

information of at least one pattern on which time domain and/or frequency domain offset needs to be performed in patterns except the basic reference signal pattern, and/or time domain offset information and/or frequency domain offset information for performing offset on the at least one pattern;

information of the first target frequency domain unit; and

information of a sub-band on which density and/or positions of reference signals needs to be changed in the first target frequency domain unit;

determining the changed target reference signal pattern corresponding to the first target frequency domain unit includes determining the changed target reference signal pattern corresponding to the first target frequency domain unit according to the first changing request.

In combination with the first aspect or any one of the above possible implementations thereof, in a possible implementation of the first aspect, determining, by the network device, the N target frequency domain units for sending the reference signals and the target reference signal pattern includes: the network device selects a first basic reference signal pattern from at least one basic reference signal pattern; the network device determines a second additional reference signal pattern; the network device determines a target reference signal pattern corresponding to a second target frequency domain unit in the N target frequency domain units according to the first basic reference signal pattern and the second additional reference signal pattern, to send the reference signals in the second target frequency domain unit according to the target reference signal pattern corresponding to the second target frequency domain unit.

In combination with the first aspect or any one of the above possible implementations thereof, in a possible implementation of the first aspect, determining, by the network device, the second additional reference signal pattern, includes performing time domain offset and/or frequency domain offset on at least one position of reference signals of the first basic reference signal pattern, to obtain the second additional reference signal pattern by the network device.

In combination with the first aspect or any one of the above possible implementations thereof, in a possible implementation of the first aspect, determining the second additional reference signal pattern includes: performing time domain offset and/or frequency domain offset on at least one position of reference signals of at least one pattern in patterns except the basic reference signal pattern, to obtain the second additional reference signal pattern by the network device.

In combination with the first aspect or any one of the above possible implementations thereof, in a possible implementation of the first aspect, determining the second additional reference signal pattern includes: the network device determines the second additional reference signal pattern from multiple additional reference signal patterns.

In combination with the first aspect or any one of the above possible implementations thereof, in a possible implementation of the first aspect, the method further includes the network device sends a fifth message to a terminal device, wherein the fifth message is used for indicating at least one of:

a quantity of basic reference signal patterns available in a system;

positions and/or density of reference signals included in the basic reference signal patterns available in a system;

a corresponding relationship between basic reference signal patterns available in a system and frequency domain units available in the system;

information of the second additional reference signal pattern; and

information of the first basic reference signal pattern.

In combination with the first aspect or any one of the above possible implementations thereof, in a possible implementation of the first aspect, the method further includes: the network device determines that the target reference signal pattern corresponding to the second target frequency domain unit needs to be changed; the network device determines a changed target reference signal pattern corresponding to the second target frequency domain unit; and the network device sends the reference signals on the second target frequency domain unit according to the changed target reference signal pattern.

In combination with the first aspect or any one of the above possible implementations thereof, in a possible implementation of the first aspect, determining, by the network device, that the target reference signal pattern corresponding to the second target frequency domain unit needs to be changed, includes: the network device determines that the target reference signal pattern corresponding to the second target frequency domain unit needs to be changed according to data currently transmitted and/or a time-frequency resource occupied by data.

In combination with the first aspect or any one of the above possible implementations thereof, in a possible implementation of the first aspect, the method further includes the network device determines a time domain unit, on which a target reference signal pattern needs to be changed, on the second target frequency domain unit according to data currently transmitted and/or a time-frequency resource occupied by data, in order to send the reference signals on the time domain unit according to the changed target reference signal pattern.

In combination with the first aspect or any one of the above possible implementations thereof, in a possible implementation of the first aspect, determining, by the network device, that the target reference signal pattern corresponding to the second target frequency domain unit needs to be changed, includes: the network device determines that the target reference signal pattern corresponding to the second target frequency domain unit needs to be changed according to a second changing request of a terminal device on the second target frequency domain unit.

In combination with the first aspect or any one of the above possible implementations thereof, in a possible implementation of the first aspect, the second changing request is used for indicating at least one of:

increasing or decreasing density of reference signals of the target reference signal pattern corresponding to the second target frequency domain unit;

density and/or positions of reference signals of the changed target reference signal pattern corresponding to the second target frequency domain unit;

information about a changed basic reference signal pattern corresponding to the second target frequency domain unit;

time domain offset information and/or frequency domain offset information for performing offset on a position of reference signals of the target reference signal pattern before the change corresponding to the second target frequency domain unit;

time domain offset information and/or frequency domain offset information for performing offset on the target reference signal pattern before the change corresponding to the second target frequency domain unit;

information of an additional reference signal pattern requested to be added or replaced;

information of at least one pattern on which time domain and/or frequency domain offset needs to be performed in patterns except the basic reference signal pattern, and/or time domain offset information and/or frequency domain offset information for performing offset on the at least one pattern;

information of the second target frequency domain unit; and

information of a sub-band on which density and/or positions of reference signal needs to be changed in the second target frequency domain unit;

determining the changed target reference signal pattern corresponding to the second target frequency domain unit includes: the network device determines the changed target reference signal pattern corresponding to the second target frequency domain unit according to the second changing request.

In a second aspect, a wireless communication method is provided. The method includes a terminal device determines N target frequency domain units for receiving reference signals and a target reference signal pattern of each target frequency domain unit in the N target frequency domain units, wherein N is an integer greater than or equal to 1; the terminal device selects a time-frequency resource for receiving the reference signals from the N target frequency domain units and time domain units corresponding to the N target frequency domain units; and the terminal device receives the reference signals on the selected time-frequency resource.

In combination with the second aspect, in a possible implementation of the second aspect, the selected time-frequency resource includes in frequency domain all sub-bands for transmitting the reference signals in the N target frequency domain units.

In combination with the second aspect, in a possible implementation of the second aspect, the selected time-frequency resource includes in frequency domain all sub-bands for transmitting the reference signals in a part of the N target frequency domain units.

In combination with the second aspect, in a possible implementation of the second aspect, the selected time-frequency resource includes in frequency domain a part of sub-bands for transmitting the reference signals in at least one frequency domain unit of the N target frequency domain units.

In combination with the second aspect or any one of the above possible implementations thereof, in a possible implementation of the second aspect, the method further includes the terminal device receives a first message sent by a network device. Herein the first message is used for indicating at least one of the following:

a quantity of frequency domain units in a system;

a sub-band occupied by each frequency domain unit;

a quantity N of the target frequency domain units; and

a sub-band occupied by the each target frequency domain unit;

determining, by the terminal device, the N target frequency domain units for receiving the reference signals and the target reference signal pattern of the each target frequency domain unit in the N target frequency domain units, includes:

the terminal device determines the N target frequency domain units according to the first message, or according to the first message and pre-configured information.

In combination with the second aspect or any one of the above possible implementations thereof, in a possible implementation of the second aspect, the method further includes the terminal device receives a second message sent by a network device, wherein the second message is used for indicating that frequency domain units for sending the reference signals are M target frequency domain units, or used for indicating frequency domain units on which sending of the reference signals is stopped in the N target frequency domain units, wherein a quantity of the frequency domain units on which sending of the reference signals is stopped is N-M; the terminal device selects a time-frequency resource for receiving the reference signal from the M target frequency domain units and time domain units corresponding to the M target frequency domain units; and the terminal device receives the reference signal on the time-frequency resource selected from the M target frequency domain units and the corresponding time domain units.

In combination with the second aspect or any one of the above possible implementations thereof, in a possible implementation of the second aspect, the method further includes the terminal device receives a third message sent by a network device, wherein the third message is used for indicating that frequency domain units for sending the reference signals are M target frequency domain units, or used for indicating M-N target frequency domain units newly added for sending the reference signals in the M target frequency domain units in addition to the N target frequency domain units; the terminal device selects a time-frequency resource for receiving the reference signals from the M target frequency domain units and time domain units corresponding to the M target frequency domain units; and the terminal device receives the reference signals on the time-frequency resource selected from the M target frequency domain units and the corresponding time domain units.

In combination with the second aspect or any one of the above possible implementations thereof, in a possible implementation of the second aspect, the method further includes the terminal device receives a fourth message sent by a network device. Herein the fourth message is used for indicating at least one of the following:

a basic reference signal pattern is enabled on a first target frequency domain unit;

a quantity of basic reference signal patterns available in a system;

positions and/or density of reference signals included in the basic reference signal patterns available in a system;

a corresponding relationship between basic reference signal patterns available in a system and frequency domain units available in the system; and

information of a target reference signal pattern corresponding to the first target frequency domain unit;

determining, by the terminal device, the N target frequency domain units for receiving the reference signals and the target reference signal pattern of the each target frequency domain unit in the N target frequency domain units, includes: the terminal device determines the target reference signal pattern of the first target frequency domain unit in the N target frequency domain units according to the fourth message, or according to the fourth message and pre-configured information.

In combination with the second aspect or any one of the above possible implementations thereof, in a possible implementation of the second aspect, the method further includes the terminal device sends a first changing request to a network device, wherein the first changing request is used for changing a target reference signal pattern corresponding to a first target frequency domain unit.

In combination with the second aspect or any one of the above possible implementations thereof, in a possible implementation of the second aspect, the first changing request is used for indicating at least one of the following:

increasing or decreasing density of reference signals of the target reference signal pattern corresponding to the first target frequency domain unit;

density and/or positions of reference signals of a changed target reference signal pattern corresponding to the first target frequency domain unit;

information of a changed basic reference signal pattern corresponding to the first target frequency domain unit;

time domain offset information and/or frequency domain offset information for performing offset on the target reference signal pattern before the change corresponding to the first target frequency domain unit;

information of an additional reference signal pattern requested to be added;

information of at least one pattern on which time domain and/or frequency domain offset needs to be performed in patterns except the basic reference signal pattern, and/or time domain offset information and/or frequency domain offset information for performing offset on the at least one pattern;

information of the first target frequency domain unit; and

information of a sub-band on which density and/or positions of the reference signals needs to be changed in the first target frequency domain unit.

In combination with the second aspect or any one of the above possible implementations thereof, in a possible implementation of the second aspect, the method further includes the terminal device receives a fifth message sent by a network device. Herein the fifth message is used for indicating at least one of:

a quantity of basic reference signal patterns available in a system;

positions and/or density of reference signals included in basic reference signal patterns available in a system;

a corresponding relationship between basic reference signal patterns available in a system and frequency domain units available in the system;

information of a target reference signal pattern corresponding to a second target frequency domain unit;

information of a second additional reference signal pattern; and

information of a first basic reference signal pattern;

determining, by the terminal device, the N target frequency domain units for receiving the reference signals and the target reference signal pattern of the each target frequency domain unit in the N target frequency domain units, includes:

the terminal device determines the target reference signal pattern of the second target frequency domain unit in the N target frequency domain units according to the fifth message, or according to the fifth message and pre-configured information.

In combination with the second aspect or any one of the above possible implementations thereof, in a possible implementation of the second aspect, the method further includes the terminal device sends a second changing request to the network device, and the second changing request is used for changing the target reference signal pattern corresponding to the second target frequency domain unit.

In combination with the second aspect or any one of the above possible implementations thereof, in a possible implementation of the second aspect, the second changing request is used for indicating at least one of:

increasing or decreasing density of reference signals of the target reference signal pattern corresponding to the second target frequency domain unit;

density and/or positions of reference signals of the changed target reference signal pattern corresponding to the second target frequency domain unit;

information of a changed basic reference signal pattern corresponding to the second target frequency domain unit;

time domain offset information and/or frequency domain offset information for performing offset on a position of reference signals of the target reference signal pattern before the change corresponding to the second target frequency domain unit;

time domain offset information and/or frequency domain offset information for performing offset on the target reference signal pattern before the change corresponding to the second target frequency domain unit;

information of an additional reference signal pattern requested to be added or replaced;

information of at least one pattern on which time domain and/or frequency domain offset needs to be performed in patterns except the basic reference signal pattern, and/or time domain offset information and/or frequency domain offset information for performing offset on the at least one pattern;

information of the second target frequency domain unit; and

information of a sub-band on which density and/or positions of reference signals needs to be changed in the second target frequency domain unit.

In a third aspect, a network device is provided. The network device may include units for implementing the methods of the first aspect or any one of possible implementations thereof.

In a fourth aspect, a terminal device is provided. The terminal device may include units for implementing the methods of the second aspect or any one of possible implementations thereof.

In a fifth aspect, a network device is provided. The network device may include a storage and a processor, the storage stores instructions, and the processor is used for calling the instructions stored in the storage to implement the methods in the first aspect or any optional implementation thereof.

In a sixth aspect, a terminal device is provided. The terminal device may include a storage and a processor, the storage stores instructions, and the processor is used for calling the instructions stored in the storage to perform the methods in the second aspect or any optional implementation thereof.

In a seventh aspect, a computer readable medium is provided. The computer readable medium stores program codes executable by a terminal device, and the program codes include instructions for executing the methods in the first aspect or various implementations thereof, or include instructions for executing the methods in the second aspect or various implementations thereof.

In an eighteenth aspect, a system chip is provided. The system chip includes an input interface, an output interface, a processor and a storage. The processor is used for executing codes in the storage, and when the codes are executed, the processor may implement the methods in the first aspect and various implementations thereof, or execute the methods in the second aspect and various implementations thereof.

### BRIEF DESCRIPTION OF DRAWINGS

To describe technical solutions of implementations of the present application more clearly, accompanying drawings that need to be used in the implementations or description for the existing art will be briefly introduced below. It is apparent that the accompanying drawings described below are only some implementations of the present application; and for a person of ordinary skill in the art, other drawings may be obtained according to these drawings without creative efforts.

FIG. 1 is a schematic diagram of a wireless communication system according to an implementation of the present application.

FIG. 2 is a schematic flowchart of a wireless communication method according to an implementation of the present application.

FIG. 3 is a schematic diagram of a reference signal pattern according to an implementation of the present application.

FIG. 4 is a schematic diagram of a reference signal pattern according to an implementation of the present application.

FIG. 5 is a schematic diagram of a reference signal pattern according to an implementation of the present application.

FIG. 6 is a schematic diagram of a reference signal pattern according to an implementation of the present application.

FIG. 7 is a schematic diagram of a reference signal pattern according to an implementation of the present application.

FIG. 8 is a schematic diagram of a reference signal pattern according to an implementation of the present application.

FIG. 9 is a schematic diagram of a reference signal pattern according to an implementation of the present application.

FIG. 10 is a schematic flowchart of a wireless communication method according to an implementation of the present application.

FIG. 11 is a schematic block diagram of a communication device according to an implementation of the present application.

FIG. 12 is a schematic block diagram of a communication device according to an implementation of the present application.

FIG. 13 is a schematic block diagram of a system chip according to an implementation of the present invention.

### DETAILED DESCRIPTION

The technical solutions in the implementations of the present application will be described below with reference to the drawings in implementations of the present application. It is apparent that the implementations described are just some implementations of the present application, and not all implementations of the present application. All the other implementations acquired by a person of ordinary skill in the art according to the implementations of the present application without creative efforts are within the protection scope of the present application.

The technical solutions of the implementations of the present application may be applied to various communication systems, such as, a Global System of Mobile communication (GSM), a Code Division Multiple Access (CDMA) system, a Wideband Code Division Multiple Access (WCDMA) system, a General Packet Radio Service (GPRS) system, a Long Term Evolution (LTE) system, an LTE Frequency Division Duplex (FDD) system, an LTE Time Division Duplex (TDD) system, a Universal Mobile Telecommunication System (UMTS) system, a Worldwide Interoperability for Microwave Access (WiMAX) communication system or a future 5G system.

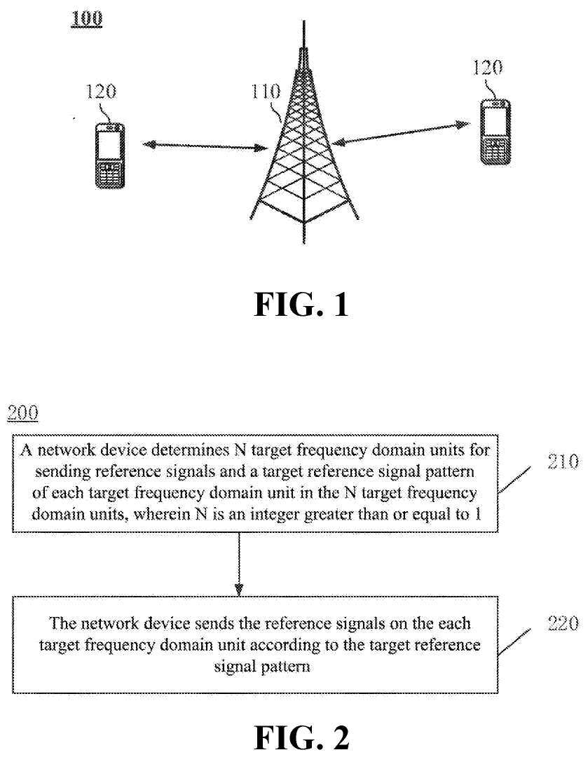

FIG. 1 shows a wireless communication system 100 to which an implementation of the present application is applied. The wireless communication system 100 may include a network device 110. The network device 110 may be a device that communicates with a terminal device. The network device 110 may provide communication coverage for a specific geographical area, and may communicate with terminal devices (e.g., UE) located within the coverage area. Optionally, the network device 110 may be a Base Transceiver Station (BTS) in a GSM system or a CDMA system, a NodeB (NB) in a WCDMA system, an Evolutional Node B (eNB or eNodeB) in an LTE system, or a radio controller in a Cloud Radio Access Network (CRAN). Or the network device may be a relay station, an access point, an on-board device, or a wearable device, a network device in a future 5G network, or a network device in a future evolved Public Land Mobile Network (PLMN), etc.

The wireless communication system 100 also includes at least one terminal device 120 located within a coverage area of the network device 110. The terminal device 120 may be mobile or fixed. Optionally, the terminal device 120 may be referred to an access terminal, a User Equipment (UE), a subscriber unit, a subscriber station, a mobile station, a remote station, a remote terminal, a mobile device, a user terminal, a terminal, a wireless communication device, a user agent, or a user device. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device, or other processing device connected to a wireless modem, an on-board device, a wearable device, a terminal device in a future 5G network, or a terminal device in a future evolving Public Land Mobile Network (PLMN), or the like.

Optionally, direct connection (Device to Device, D2D) communication between terminals may be performed between the terminal devices 120.

Optionally, the 5G system or network may also be referred to as a New Radio (NR) system or network.

FIG. 1 exemplifies one network device and two terminal devices. Optionally, the wireless communication system 100 may include multiple network devices, and there may include another quantity of terminal devices within the coverage area of each network device, which is not limited by the implementations of the present application.

Optionally, the wireless communication system 100 may also include other network entities such as a network controller, a mobile management entity, and implementations of the present application are not limited thereto.

It should be understood that the terms “system” and “network” are often used interchangeably herein. The term “and/or” in this document is merely an association relationship for describing associated objects, and indicates that there may be three relationships, for example, A and/or B may indicate three situations: A alone, A and B, and B alone. In addition, the symbol “/” in this document generally indicates that objects of the former and the latter connected by “/” has an “or” relationship.

FIG. 2 is a schematic flowchart of a wireless communication method 200 according to an implementation of the present application. The method 200 may optionally be applied to the system shown in FIG. 1, but is not limited thereto. As shown in FIG. 2, the method 200 includes acts 210-220.

In 210, a network device determines N target frequency domain units for sending reference signals and a target reference signal pattern of each target frequency domain unit in the N target frequency domain units, wherein N is an integer greater than or equal to 1.

Optionally, division of frequency domain units may be performed on all or part of sub-bands of a system.

Optionally, one frequency domain unit may include one or more sub-bands.

Optionally, bandwidths occupied by frequency domain units available in the system may be the same or may be different.

Optionally, the frequency domain unit may be referred to as a block.

Optionally, a size of each frequency domain unit may equal to a size of frequency domain occupied by a certain quantity of Physical Resource Blocks (PRBs).

Optionally, the implementations of the present application do not limit a size of time domain occupied by each frequency domain unit. For example, time domain occupied by each frequency domain unit may be at least one OFDM symbol, at least one time slot, at least one mini time slot, at least one subframe or at least one radio frame.

Optionally, the network device determines the N target frequency domain units from at least one frequency domain unit available in a system.

Specifically, the network device determines a quantity N of the target frequency domain units for sending the reference signals according to at least one of: a quantity of terminal devices currently located in the system, a load condition of the system and a service condition of each terminal device in the system. The network device determines the N target frequency domain units from at least one frequency domain unit available in the system.

Optionally, the network device sends a first message, wherein the first message is used for indicating at least one of:

a quantity of frequency domain units available in the system;

a sub-band occupied by each frequency domain unit;

a quantity N of the target frequency domain units; and

a sub-band occupied by each target frequency domain unit.

Optionally, if the first message only carries a part of the above contents, other contents may be specified by a protocol, that is, may be preset in the terminal device and the network device.

Optionally, the first message may be sent periodically or in an event trigger mode except the periodic sending mode.

Optionally, the first message may be a message sent through a Physical Broadcast Channel (PBCH), or System Information (SI), a Radio Resource Control (RRC) message, a Media Access Control (MAC) Control Element (CE), or Downlink Control Information (DCI), or other messages specified in the protocol.

Optionally, a format of the first message may be different for different information contents.

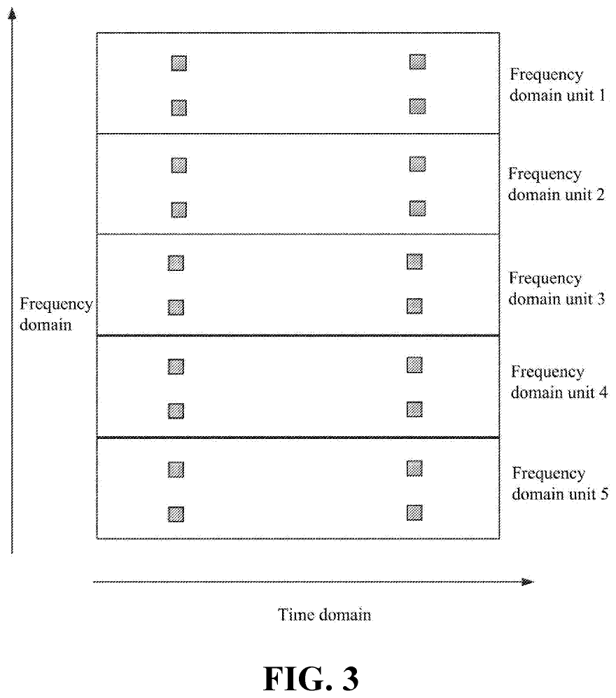

For example, a sending mode of reference signals shown in FIG. 3 may be known to the terminal device through several ways below, wherein a gray square position in the FIG. 3 is a sending position of a reference signal, and in other figures that is similar.

In one way, the network device may inform the terminal device through SI that a size of each frequency domain unit is a size of frequency domain occupied by X PRBs, the current terminal device may see 5 frequency domain units, and each frequency domain unit in the 5 frequency domain units sends reference signals.

In one way, the terminal device and the network device preset a size of each frequency domain unit, for example, the size is a size of frequency domain occupied by X PRBs. The network device may inform through SI that the current terminal device may see 5 frequency domain units, and each frequency domain unit sends the reference signals.

In one way, the network device may inform the terminal device through SI that a size of each frequency domain unit is a size of frequency domain occupied by X PRBs, and the current terminal device may see 5 frequency domain units, and may inform the terminal device through an RRC message that each frequency domain unit in the 5 frequency domain units sends the reference signals.

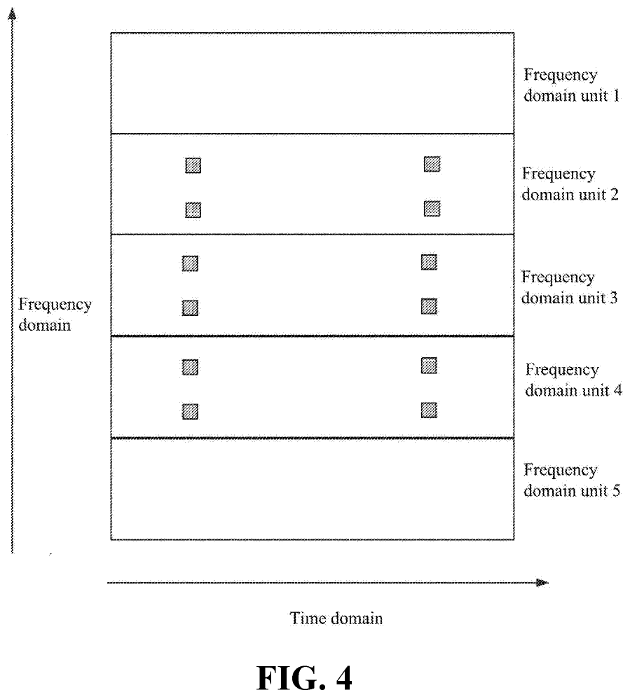

For example, a sending mode of reference signals shown in FIG. 4 may be known to the terminal device through following ways, wherein a gray square position in the FIG. 4 is a sending position of a reference signal.

In one way, the network device may inform the terminal device through SI that a size of each frequency domain unit is a size of frequency domain occupied by X PRBs, the current terminal device may see 5 frequency domain units, and frequency domain units 2, 3 and 4 in the 5 frequency domain units send reference signals.

In one way, the terminal device and the network device preset the size of each frequency domain unit, for example, the size is a size of frequency domain occupied by X PRBs. The network device may inform through SI that the current terminal device may see 5 frequency domain units, and frequency domain units 2, 3 and 4 in the 5 frequency domain units send e reference signals.

In one way, the network device may inform the terminal device through SI that a size of each frequency domain unit is a size of frequency domain occupied by X PRBs, and the current terminal device may see 5 frequency domain units, and terminal device may be informed the through an RRC message that frequency domain units 2, 3 and 4 in the 5 frequency domain units send the reference signals.

The situation shown in FIG. 4 or a similar situation is mainly applied to a situation in which service load of the network is relatively small, the network device may concentrate services on part frequency bands and switch off the signals on other frequency bands as much as possible, thereby power consumption of the network device is reduced, and at the same time, interferences to other cells can be also reduced.

Optionally, in an implementation of the present application, the network device selects a target reference signal pattern corresponding to a first target frequency domain unit in the N target frequency domain units from at least one basic reference signal pattern available in the system, to send reference signals on the first target frequency domain unit according to the target reference signal pattern corresponding to the first target frequency domain unit.

Optionally, the network device sends a fourth message to the terminal device, wherein the fourth message is used for indicating at least one of the following:

a basic reference signal pattern is enabled on the first target frequency domain unit;

a quantity of basic reference signal patterns available in the system;

positions and/or density of reference signals included in basic reference signal patterns available in the system;

a corresponding relationship between basic reference signal patterns available in the system and frequency domain units available in the system; and

information of the target reference signal pattern corresponding to the first target frequency domain unit.

For example, assuming that a quantity of basic reference signal patterns available in the current system is only one, then the fourth message may only indicate that enables the basic reference signal pattern is enabled on the first target frequency domain unit, and the terminal device may receive the reference signals according to the one basic reference signal pattern that is preset.

For example, the fourth message may indicate the corresponding relationship between the basic reference signal patterns available in the system and the frequency domain units available in the system, then on a certain frequency domain unit, the reference signals may be received according to the basic reference signal pattern corresponding to the frequency domain unit. Herein, the fourth message may carry positions and/or density of the reference signals included in the basic reference signal pattern corresponding to each frequency domain unit, or the fourth message may carry a serial number of the basic reference signal pattern corresponding to each frequency domain unit, and the terminal device may preset the positions and/or density of the reference signals included in the each basic reference signal pattern.

For example, the fourth message may carry the information of the target reference signal pattern corresponding to the first target frequency domain unit, which may be the serial number of the target reference signal pattern, or the positions and/or density of the reference signals included in the target reference signal pattern, then the terminal device may receive the reference signals on the first target frequency domain unit based on the fourth message.

Optionally, the fourth message may be a message sent through a PBCH, or system information, an RRC message, a MAC CE, or DCI, or other messages specified in a protocol.

Optionally, the first target frequency domain unit may be any one of the selected N target frequency domain units.

Optionally, the network device determines that the target reference signal pattern corresponding to the first target frequency domain unit needs to be changed; the network device determines a changed target reference signal pattern corresponding to the first target frequency domain unit; and the network device sends the reference signals on the first target frequency domain unit according to the changed target reference signal pattern.

Optionally, changing the target reference signal pattern corresponding to the first target frequency domain unit may be to change time domain density and/or frequency domain density of the reference signal pattern. Specifically, it may be to increase the time domain density and/or the frequency domain density, or to reduce the time domain density and/or the frequency domain density, or to increase the time domain density and reduce the frequency domain density, or to increase the frequency domain density and reduce the time domain density.

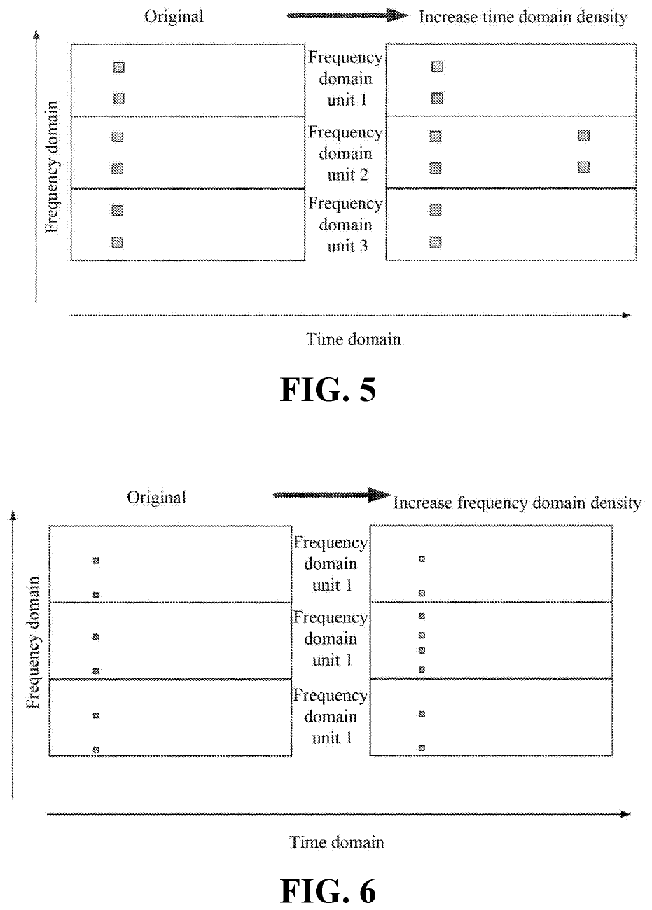

For example, as shown in FIG. 5, assuming that the first target frequency domain unit is a frequency domain unit 2, the time domain density of the time domain unit 2 may be increased.

For example, as shown in FIG. 6, assuming that the first target frequency domain unit is s frequency domain unit 2, the frequency domain density of the time domain unit 2 may be increased.

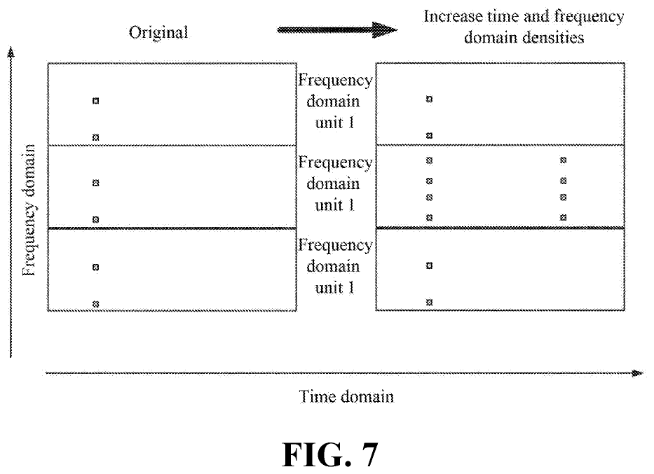

For example, as shown in FIG. 7, assuming that the first target frequency domain unit is the frequency domain unit 2, the frequency domain density and the time domain density of the time domain unit 2 may be increased.

Optionally, the network device may determine a first additional reference signal pattern; and determine the changed target reference signal pattern according to the target reference signal pattern before the change and the first additional reference signal pattern. Herein, the changed target reference signal pattern may be composed of the target reference signal pattern before the change and the first additional reference signal pattern together.

Several ways for determining the first additional reference signal pattern will be introduced below, but it should be understood that implementations of the present application are not limited thereto.

In an implementation, time domain offset and/or frequency domain offset is performed on at least one position of the reference signals of the target reference signal pattern before the change corresponding to the first target frequency domain unit to obtain the first additional reference signal pattern.

In an implementation, time domain offset and/or frequency domain offset is performed on at least one position of the reference signals of at least one pattern in patterns except the basic reference signal pattern to obtain the first additional reference signal pattern.

In an implementation, the first additional reference signal pattern is determined from multiple additional reference signal patterns.

Optionally, it may be determined that the target reference signal pattern corresponding to the first target frequency domain unit needs to be changed according to a first changing request sent by a terminal device on the first target frequency domain unit.

Specifically, the terminal device on the first target frequency domain unit may determine that the reference signal pattern on the first target frequency domain unit needs to be changed according to a current service requirement, and may send a changing request to the network device. The network device may determine whether the target pattern on the first target frequency domain unit needs to be changed according to the request of the terminal device, and if yes, the changing may be made.

Optionally, the first changing request is used for indicating at least one of following (wherein the indication here represents an expectation of the terminal device):

increasing or decreasing density of reference signals of the target reference signal pattern corresponding to the first target frequency domain unit;

density and/or positions of reference signals of the changed target reference signal pattern corresponding to the first target frequency domain unit;

information of a changed basic reference signal pattern corresponding to the first target frequency domain unit;

time domain offset information and/or frequency domain offset information for performing offset on the target reference signal pattern before the change corresponding to the first target frequency domain unit;

information of an additional reference signal pattern requested to be added;

information of at least one pattern on which time domain and/or frequency domain offset needs to be performed in patterns except the basic reference signal pattern, and/or time domain offset information and/or frequency domain offset information for performing offset on the at least one pattern; and

information of the first target frequency domain unit or a sub-band on which positions and/or density of reference signals needs to be changed in the first target frequency domain unit.

For example, the first changing request is used for requesting to increase or decrease the density of the reference signals of the target reference signal pattern corresponding to the first target frequency domain unit, the network device may increase or decrease the density of the reference signals of the target reference signal pattern, wherein the first changing request may carry a specific increase or decrease value, or may not carry the specific increase or decrease value.

For example, the terminal device may notify the network device of the information of a changed basic reference signal pattern expected by the terminal device through the first changing request, and then the network device may determine whether the basic reference signal pattern corresponding to the first target frequency domain unit needs to be changed in combination with the first changing request. Herein, the first changing request may carry a serial number of the changed basic reference signal pattern, density and/or positions of the reference signals.

Optionally, in an implementation of the present application, changing the target reference signal pattern corresponding to the first target frequency domain unit may be to only change the basic reference signal pattern without adding an additional reference signal pattern.

Optionally, the network device selects a first basic reference signal pattern from at least one basic reference signal pattern; the network device determines a second additional reference signal pattern; and the network device determines a target reference signal pattern corresponding to a second target frequency domain unit in the N target frequency domain units according to the first basic reference signal pattern and the second additional reference signal pattern, to send the reference signals in the second target frequency domain unit according to the target reference signal pattern corresponding to the second target frequency domain unit.

Several ways for determining the second additional reference signal pattern will be introduced below.

In an implementation, time domain offset and/or frequency domain offset is performed on at least one position of reference signals of the first basic reference signal pattern, to obtain the second additional reference signal pattern by the network device.

In an implementation, time domain offset and/or frequency domain offset is performed on at least one position of reference signals of at least one pattern in patterns except the basic reference signal pattern, so that the network device obtains the second additional reference signal pattern.

In an implementation, the network device determines the second additional reference signal pattern from multiple additional reference signal patterns.

Optionally, the network device sends a fifth message to a terminal device, wherein the fifth message is used for indicating at least one of:

a quantity of basic reference signal patterns available in a system;

positions and/or density of reference signals included in a basic reference signal patterns available in a system;

a corresponding relationship between basic reference signal patterns available in a system and frequency domain units available in the system;

information of a target reference signal pattern corresponding to the second target frequency domain unit;

information of the second additional reference signal pattern, for example, time domain offset information and/or frequency domain offset information of the second additional reference signal compared to the first basic reference signal pattern or other reference signal patterns, or a serial number of the second additional reference signal pattern; and

information of the first basic reference signal pattern, for example, a serial number of the first basic reference signal pattern, or positions and/or density of the reference signals, etc.

Optionally, the fifth message may be a message sent through a PBCH, or system information, an RRC message, a MAC CE, or DCI, or other messages specified in a protocol.

Optionally, the network device determines that the target reference signal pattern corresponding to the second target frequency domain unit needs to be changed; the network device determines a changed target reference signal pattern corresponding to the second target frequency domain unit; and the network device sends the reference signals on the second target frequency domain unit according to the changed target reference signal pattern.

Optionally, the network device determines according to a second changing request of a terminal device on the second target frequency domain unit that the target reference signal pattern corresponding to the second target frequency domain unit needs to be changed.

Optionally, the second changing request is used for indicating at least one of:

increasing or decreasing density of reference signals of the target reference signal pattern corresponding to the second target frequency domain unit;

density and/or positions of the reference signal of the changed target reference signal pattern corresponding to the second target frequency domain unit;

information of a changed basic reference signal pattern corresponding to the second target frequency domain unit;

time domain offset information and/or frequency domain offset information for performing offset on a position of reference signals of the target reference signal pattern before the change corresponding to the second target frequency domain unit;

time domain offset information and/or frequency domain offset information for performing offset on the target reference signal pattern before the change corresponding to the second target frequency domain unit;

information of an additional reference signal pattern requested to be added or replaced;

information of at least one pattern on which time domain and/or frequency domain offset needs to be performed in patterns except the basic reference signal pattern, and/or time domain offset information and/or frequency domain offset information for performing offset on the at least one pattern; and

information of the second target frequency domain unit or a sub-band on which positions and/or a density of the reference signals needs to be changed in the second target frequency domain unit.

Optionally, after the target reference signal pattern of the target frequency domain unit is changed, indication information may be sent to indicate to change a target reference signal pattern of one certain frequency domain unit or change target reference signal patterns of some frequency domain units.

Optionally, in an implementation of the present application, the network device may determine a frequency domain unit on which a reference signal pattern needs to be changed according to data currently transmitted and/or a time-frequency resource occupied by data.

Optionally, the network device may further determine a sub-band, on which density of reference signals needs to be changed, on the frequency domain unit.

Optionally, the network device may further determine a frequency domain unit, on which a reference signal pattern needs to be changed, on the frequency domain unit according to data currently transmitted and/or a time-frequency resource occupied by data.

Optionally, a quantity of the frequency domain units on which the reference signal pattern is changed each time (e.g., within the same time domain unit) may be one or more.

In 220, the network device sends the reference signals on the each target frequency domain unit according to the target reference signal pattern.

Optionally, before the network device sends the reference signals on the target frequency domain unit according to the target reference signal pattern, the network device schedules a terminal device in a system to the N target frequency domain units.

Optionally, in an implementation of the present application, the network device determines that the quantity of the target frequency domain units for sending the reference signals needs to be changed from N to M, wherein M is a positive integer that is not equal to N; the network device determines M target frequency domain units for sending the reference signals; and the network device sends the reference signals on the M target frequency domain units.

Specifically, the network device determines that the quantity of the target frequency domain units that send the reference signals needs to be changed from N to M according to at least one of: a quantity of terminal devices currently located in the system, a load condition of the system and a service condition of each terminal device in the system.

Optionally, N is smaller than M, and the M target frequency domain units include the N target frequency domain units, and the method further includes: the network device sends a third message, wherein the third message is used for indicating that frequency domain units for sending the reference signals are the M target frequency domain units, or used for indicating M-N target frequency domain units newly added for sending the reference signals in the M target frequency domain units in addition to the N target frequency domain units.

Herein, the Network device may activate sending of the reference signals on the frequency domain units newly added.

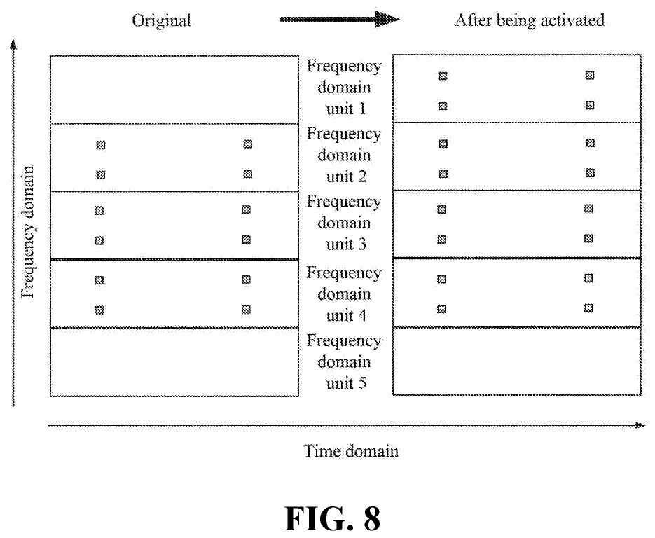

For example, as shown in FIG. 8, the network device originally used three frequency domain units, namely frequency domain units 2, 3 and 4, to send reference signals. The network according to factors such as system load, and then the network device may notify the terminal device, through signaling, that a frequency domain unit 1 is newly added for sending the reference signals. Therefore, the terminal device may receive the reference signals on the frequency domain units 1, 2, 3 and 4.

Optionally, N is greater than M, and the network device sends a second message, wherein the second message is used for indicating that frequency domain units for sending the reference signals are the M target frequency domain units, or used for indicating frequency domain units on which sending of the reference signals is stopped in the N target frequency domain units, wherein a quantity of frequency domain units on which sending of the reference signals is stopped is N-M.

Herein, the Network device may deactivate sending of the reference signals on a frequency domain unit.

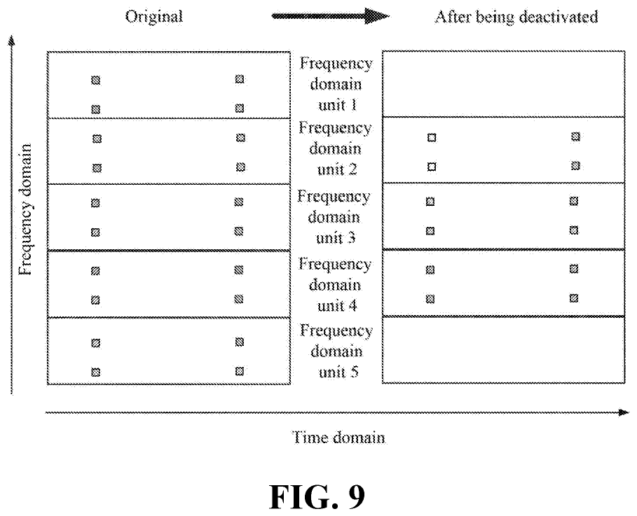

For example, as shown in FIG. 9, the network device originally used five frequency domain units, i.e., frequency domain units 1, 2, 3, 4 and 5, to send the reference signals. The network device determines that the reference signals needs to be sent on smaller frequency bands according to factors such as the system load, and then the network device may notify the terminal device through signaling to stop sending the reference signals on frequency domain units 1 and 5. Therefore, the terminal device may receive the reference signals on the frequency domain units 2, 3 and 4.

Optionally, in an implementation of the present application, the frequency domain units may be grouped, one group may include at least one frequency domain unit, and the frequency domain units may be activated or deactivated in group.

Optionally, the second message or the third message in an implementation of the present application may include at least one of: a system message; an RRC message; a MAC CE; and DCI, wherein the DCI may be UE-specific DCI, Common DCI, and UE group-specific DCI.

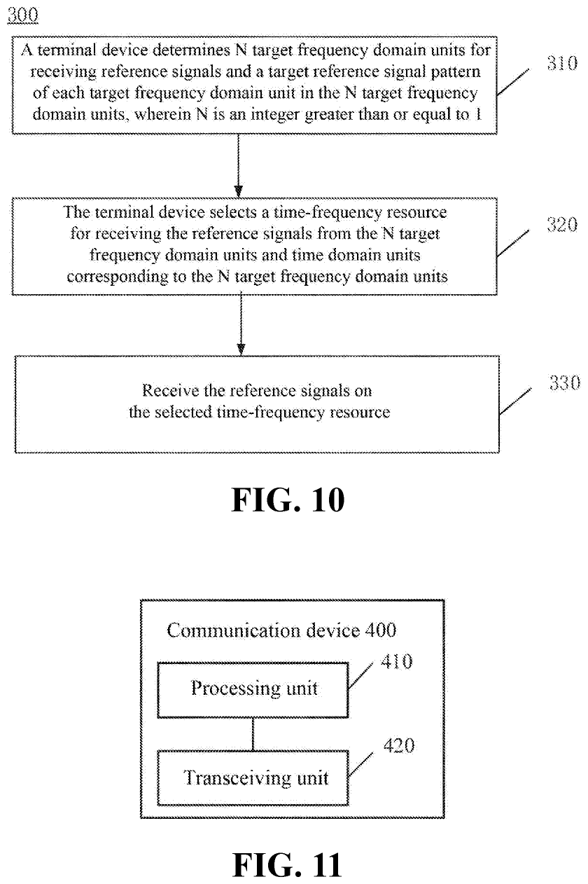

FIG. 10 is a schematic flowchart of a wireless communication method 300 according to an implementation of the present application. As shown in FIG. 10, the method 300 includes acts 310-330.

In 310, a terminal device determines N target frequency domain units for receiving reference signals and a target reference signal pattern of each target frequency domain unit in the N target frequency domain units, wherein N is an integer greater than or equal to 1.

In 320, the terminal device selects a time-frequency resource for receiving the reference signals from the N target frequency domain units and time domain units corresponding to the N target frequency domain units.

In 330, the terminal device receives the reference signals on the selected time-frequency resource.

Optionally, the selected time-frequency resource includes in frequency domain all sub-bands for transmitting the reference signals in the N target frequency domain units.

Optionally, the terminal device may select a resource for receiving the reference signals according to data currently transmitted and/or a time-frequency resource occupied by data.

Optionally, the selected time-frequency resource includes in frequency domain all sub-bands for transmitting the reference signal in a part of the N target frequency domain units.

Specifically, the terminal device may select a frequency domain unit that needs to receive the reference signals from N frequency domain units according to data currently transmitted and/or a time-frequency resource occupied by data, and receive the reference signals on a time-frequency resource composed of the selected frequency domain unit and the corresponding time domain unit.

Optionally, the selected time-frequency resource includes in frequency domain a part of sub-bands for transmitting the reference signals in at least one frequency domain unit of the N target frequency domain units.

Specifically, the terminal device may select a frequency domain unit from the N frequency domain units according to data currently transmitted and/or a time-frequency resource occupied by data, select a sub-band from the selected frequency domain unit, and receive the reference signals on a time-frequency resource composed of the selected sub-bands and the corresponding time-domain resource.

Optionally, the terminal device may further select a time-frequency resource for receiving the reference signals according to other ways, which is not specifically limited by the implementations of the present application.

Optionally, the terminal device receives a first message sent by a network device; wherein the first message is used for indicating at least one of:

a quantity of frequency domain units in a system;

a sub-band occupied by each frequency domain unit;

a quantity N of the target frequency domain units; and

a sub-band occupied by each target frequency domain unit.

The terminal device determines the N target frequency domain units according to the first message, or according to the first message and pre-configured information.

Optionally, the terminal device receives a third message sent by the network device, wherein the third message is used for indicating that frequency domain units for sending the reference signals are the M target frequency domain units, or used for indicating M-N target frequency domain units newly added for sending the reference signals in the M target frequency domain units in addition to the N target frequency domain units; selects a time-frequency resource for receiving the reference signals from the M target frequency domain units and time domain units corresponding to the M target frequency domain units; and receives the reference signals on the time-frequency resource selected from the M target frequency domain units and the corresponding time domain units.

Optionally, the terminal device receives a second message sent by the network device, wherein the second message is used for indicating that frequency domain units for sending the reference signals are the M target frequency domain units, or used for indicating frequency domain units on which sending of the reference signals is stopped in the N target frequency domain units, wherein a quantity of the frequency domain units on which sending of the reference signals is stopped is N-M. The terminal device selects a time-frequency resource for receiving the reference signals from the M target frequency domain units and time domain units corresponding to the M target frequency domain units; and receives the reference signal on the time-frequency resource selected from the M target frequency domain units and the corresponding time domain units.

Optionally, the terminal device receives a fourth message sent by a network device; wherein the fourth message is used for indicating at least one of:

a basic reference signal pattern is enabled on a first target frequency domain unit; a quantity of basic reference signal patterns available in a system;

positions and/or density of reference signals included in basic reference signal patterns available in a system;

a corresponding relationship between basic reference signal patterns available in a system and frequency domain units available in the system; and

information of a target reference signal pattern corresponding to a first target frequency domain unit.

determining, by the terminal device, the N target frequency domain units for receiving the reference signals and the target reference signal pattern of the each target frequency domain unit in the N target frequency domain units, includes:

the terminal device determines the target reference signal pattern of a first target frequency domain unit in the N target frequency domain units according to the fourth message, or according to the fourth message and pre-configured information.

Optionally, the method further includes: the terminal device sends a first changing request to a network device, wherein the first changing request is used for changing a target reference signal pattern corresponding to a first target frequency domain unit.

Optionally, the first changing request is used for indicating at least one of:

increasing or decreasing density of reference signals of the target reference signal pattern corresponding to the first target frequency domain unit;

density and/or positions of reference signals of the changed target reference signal pattern corresponding to the first target frequency domain unit;

information of a changed basic reference signal pattern corresponding to the first target frequency domain unit;

time domain offset information and/or frequency domain offset information for performing offset on the target reference signal pattern before the change corresponding to the first target frequency domain unit;

information of an additional reference signal pattern requested to be added; and

information of at least one pattern on which time domain and/or frequency domain offset needs to be performed in patterns except a basic reference signal pattern, and/or time domain offset information and/or frequency domain offset information for performing offset on the at least one pattern.

Optionally, the method further includes: the terminal device receives a fifth message sent by a network device, wherein the fifth message is used for indicating at least one of:

a quantity of basic reference signal patterns available in a system;

positions and/or density of reference signals included in basic reference signal patterns available a system;

a corresponding relationship between basic reference signal patterns available in a system and frequency domain units available in the system;

information of a target reference signal pattern corresponding to a second target frequency domain unit;

information of a second additional reference signal pattern; and

information of a first basic reference signal pattern;

determining, by the terminal device, the N target frequency domain units for receiving the reference signals and the target reference signal pattern of the each target frequency domain unit in the N target frequency domain units, includes: the terminal device determines the target reference signal pattern of the second target frequency domain unit in the N target frequency domain units according to the fifth message, or according to the fifth message and pre-configured information.

Optionally, the method further includes: the terminal device sends a second changing request to the network device, wherein the second changing request is used for changing the target reference signal pattern corresponding to the second target frequency domain unit.

Optionally, the second changing request is used for indicating at least one of:

increasing or decreasing density of reference signals of the target reference signal pattern corresponding to the second target frequency domain unit;

density and/or positions of reference signals of the changed target reference signal pattern corresponding to the second target frequency domain unit;

information of a changed basic reference signal pattern corresponding to the second target frequency domain unit;

time domain offset information and/or frequency domain offset information for performing offset on a position of reference signals of the target reference signal pattern before the change corresponding to the second target frequency domain unit;

time domain offset information and/or frequency domain offset information for performing offset on the target reference signal pattern before the change corresponding to the second target frequency domain unit;

information of an additional reference signal pattern requested to be added or replaced; and

information of at least one pattern on which time domain and/or frequency domain offset needs to be performed in patterns except a basic reference signal pattern, and/or time domain offset information and/or frequency domain offset information for performing offset on the at least one pattern.

Optionally, in an implementation of the present application, the terminal device UE may apply to the network for changing the positions and/or density of the reference signals of the frequency domain unit where the terminal device UE is located according to its own service type, transmission situation, movement speed, etc.

Optionally, in an implementation of the present application, the terminal device may perform fine time and frequency synchronization/tracking according to the reference signals.

The requirements and characteristics corresponding to the fine time and frequency synchronization/tracking are as follows.

Frequency domain density of reference signals affects a Power Delay Profile (PDP) extension range of a channel and recognition of multipath. If the frequency domain density is too low, the terminal device can only recognize a multipath with a coarse granularity, and cannot estimate a multipath with a relatively large delay.

The time domain density of the reference signals affects frequency offset estimation and time-varying tracking of the channel. If the time domain density is too low, the terminal device cannot estimate a large frequency spectrum and cannot track time variation of the channel in time.

Different transmission parameters, such as a constellation modulation level and a quantity of transmission layers, have different requirements on the time and frequency synchronization accuracy.

Different terminal devices also have different requirements on the time-frequency density of corresponding reference signals. For example, a terminal device in a high-speed movement at least needs reference signals of high time-domain density to ensure certain time-frequency synchronization accuracy.

In the implementations of the present application, the sending of the reference signals is performed on demand, which can meet the above-mentioned requirements and characteristics corresponding to the fine time and frequency synchronization.

It should be understood that acts performed by the terminal device in the method 300 may refer to the description in the method 200, and will not be repeated here for the sake of brevity.

Therefore, the network device may determine the N target frequency domain units for sending the reference signals and the target reference signal pattern of each target frequency domain unit in the N target frequency domain units on demand, thereby improving the utilization rate and flexibility of resources.

FIG. 11 is a schematic diagram of a communication device 400 according to an implementation of the present application. As shown in FIG. 11, the communication device 400 may include a processing unit 410 and a transceiving unit 420.

Optionally, various units included in the communication device 400 can implement the corresponding functions implemented by the network device in the wireless communication method shown in FIG. 2, which will not be described repeatedly here for the sake of brevity.

Optionally, various units included in the communication device 400 can implement the corresponding functions implemented by the terminal device in the wireless communication method shown in FIG. 10, which will not be described repeatedly here for the sake of brevity.

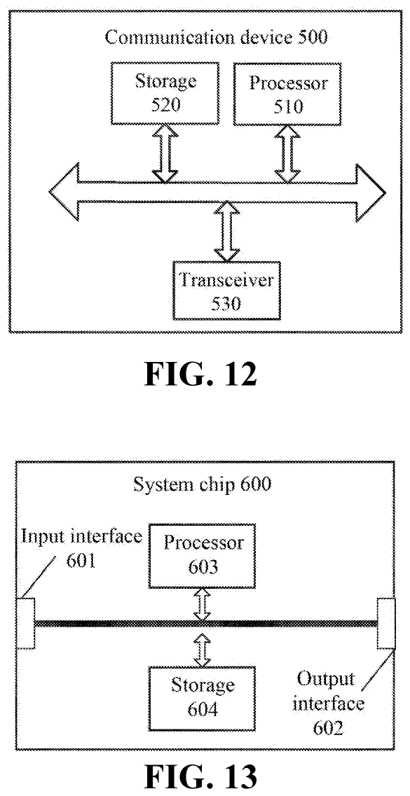

FIG. 12 is a schematic block diagram of a communication device 500 according to an implementation of the present application. As shown in FIG. 12, the communication device 500 includes a processor 510 and a storage 520. The storage 520 may store program codes, and the processor 510 may execute the program codes stored in the storage 520.

Optionally, as shown in FIG. 12, the communication device 500 may include a transceiver 530, and the processor 510 may control the transceiver 530 to communicate with the external.

Optionally, the processor 510 may call the program codes stored in the storage 520 to perform corresponding acts of network device in the method 200 shown in FIG. 2, which will not be described here repeatedly for brevity.

Optionally, the processor 510 may call the program codes stored in the storage 520 to perform corresponding acts of terminal device in the method 300 shown in FIG. 10, which will not be described here repeatedly for brevity.

FIG. 13 is a schematic diagram of structure of a system chip 600 according to an implementation of the present invention. The system chip 600 of FIG. 13 includes an input interface 601, an output interface 602, a processor 603, and a storage 604, which may be connected through internal communication connection lines. The processor 603 is used for executing codes in the storage 604.

Optionally, when the codes are executed, the processor 603 implements the method implemented by the network device in the method 200 shown in FIG. 2. For the sake of brevity, it will not be repeated here.

Optionally, when the codes are executed, the processor 603 implements the method implemented by the terminal device in the method 300 shown in FIG. 10. For the sake of brevity, it will not be repeated here.

Those of ordinary skill in the art may recognize that various exemplary units and algorithm acts described in the implementations disclosed herein may be implemented in electronic hardware, or a combination of computer software and electronic hardware. Whether these functions are implemented in hardware or software depends on the specific application and design constraints of the technical solutions. Skilled artisans may use different methods to implement the described functions for each particular application, but such implementation should not be considered to be beyond the scope of the present application.

Those skilled in the art may clearly understand that for convenience and conciseness of description, the specific working processes of the system, device and unit described above may refer to the corresponding processes in the aforementioned method implementations and will not be described here.

In several implementations provided by the present application, it should be understood that the disclosed systems, devices and methods may be implemented in other ways. For example, the device implementations described above are only illustrative, for example, the division of the units is only a logical function division, and there may be other division manners in actual implementation, for example, multiple units or components may be combined or integrated into another system, or some features may be ignored or not executed. On the other hand, the mutual coupling or direct coupling or communication connection shown or discussed may be indirect coupling or communication connection through some interface, device or unit, and may be in electrical, mechanical or other forms.

The units described as separate components may or may not be physically separated, and the component shown as a unit may or may not be a physical unit, i.e., it may be located in one place or may be distributed over multiple network units. Some or all of the units may be selected according to actual needs to achieve the purpose of solutions of the implementations of the present application.

In addition, various functional units in various implementations of the present application may be integrated in one processing unit, or the various units may be physically present separately, or two or more units may be integrated in one unit.

The functions may be stored in a computer readable storage medium if the functions implemented in the form of software functional units and sold or used as a separate product. Based on this understanding, the technical solutions of the present application, in essence, or the part contributing to the prior art, or the part of the technical solution, may be embodied in the form of a software product stored in a storage medium, including a variety of instructions for causing a computer device (which may be a personal computer, a server, or a network device) to perform all or part of the acts of the method described in various implementations of the present application. The aforementioned storage media include a U disk, a mobile hard disk, a read-only memory, a random access memory, a magnetic disk or an optical disk, and other media that is capable of storing program codes.

What are described above are merely exemplary implementations of the present application, but the protection scope of the present application is not limited thereto. Any variation or substitution that may be easily conceived by a person skilled in the art within the technical scope disclosed by the present application shall be included within the protection scope of the present application. Therefore, the protection scope of the present application shall be subject to the protection scope of the claims.

1-30. (canceled)

31. A method for wireless communication, comprising:
determining, by a terminal device, N target frequency domain units for receiving reference signals and a target reference signal pattern of each target frequency domain unit in the N target frequency domain units, wherein N is an integer greater than or equal to 1;
selecting, by the terminal device, a time-frequency resource for receiving the reference signals from the N target frequency domain units and time domain units corresponding to the N target frequency domain units; and
receiving, by the terminal device, the reference signals on the selected time-frequency resource.

32. The method according to claim 31, wherein the selected time-frequency resource comprises in frequency domain all sub-bands for transmitting the reference signals in the N target frequency domain units.

33. The method according to claim 31, wherein the selected time-frequency resource comprises in frequency domain all sub-bands for transmitting the reference signals in a part of the N target frequency domain units.

34. The method according to claim 31, wherein the selected time-frequency resource comprises in frequency domain a part of sub-bands for transmitting the reference signals in at least one frequency domain unit of the N target frequency domain units.

35. The method according to claim 31, wherein the method further comprises:
receiving, by the terminal device, a first message sent by a network device, wherein the first message is used for indicating at least one of:
a quantity of frequency domain units in a system;
a sub-band occupied by each frequency domain unit;
a quantity N of the target frequency domain units; and
a sub-band occupied by each target frequency domain unit; and
determining, by the terminal device, the N target frequency domain units for receiving the reference signals and the target reference signal pattern of the each target frequency domain unit in the N target frequency domain units, comprises:
determining, by the terminal device, the N target frequency domain units according to the first message, or according to the first message and pre-configured information.

36. The method according to claim 31, wherein the method further comprises:
receiving, by the terminal device, a second message sent by a network device, wherein the second message is used for indicating that frequency domain units for sending the reference signals are M target frequency domain units, or used for indicating frequency domain units on which sending of the reference signals is stopped in the N target frequency domain units, wherein a quantity of the frequency domain units on which sending of the reference signals is stopped is N-M;
selecting, by the terminal device, a time-frequency resource for receiving the reference signals from the M target frequency domain units and time domain units corresponding to the M target frequency domain units; and
receiving, by the terminal device, the reference signals on the time-frequency resource selected from the M target frequency domain units and the corresponding time domain units.

37. The method according to claim 31, wherein the method further comprises:
receiving, by the terminal device, a third message sent by a network device, wherein the third message is used for indicating that frequency domain units for sending the reference signals are M target frequency domain units, or used for indicating M-N target frequency domain units newly added for sending the reference signals in the N-M target frequency domain units in addition to the N target frequency domain units;
selecting, by the terminal device, a time-frequency resource for receiving the reference signals from the M target frequency domain units and time domain units corresponding to the M target frequency domain units; and
receiving, by the terminal device, the reference signals on the time-frequency resource selected from the M target frequency domain units and the corresponding time domain units.

38. The method according to claim 31, wherein the method further comprises:
receiving, by the terminal device, a fourth message sent by a network device, wherein the fourth message is used for indicating at least one of:
a basic reference signal pattern is enabled on a first target frequency domain unit;
a quantity of basic reference signal patterns available in a system;
at least one of positions or density of reference signals included in basic reference signal patterns available in a system;
a corresponding relationship between basic reference signal patterns available in a system and frequency domain units available in the system; and
information of a target reference signal pattern corresponding to the first target frequency domain unit; and
determining, by the terminal device, the N target frequency domain units for receiving the reference signals and the target reference signal pattern of the each target frequency domain unit in the N target frequency domain units, comprises:
determining, by the terminal device, the target reference signal pattern of the first target frequency domain unit in the N target frequency domain units according to the fourth message, or according to the fourth message and pre-configured information.

39. The method according to claim 31, wherein the method further comprises:
sending, by the terminal device, a first changing request to a network device, wherein the first changing request is used for changing a target reference signal pattern corresponding to a first target frequency domain unit.

40. The method according to claim 39, wherein the first changing request is used for indicating at least one of:
increasing or decreasing density of reference signals of the target reference signal pattern corresponding to the first target frequency domain unit;
at least one of density or positions of reference signals of a changed target reference signal pattern corresponding to the first target frequency domain unit;
information of a changed basic reference signal pattern corresponding to the first target frequency domain unit;
at least one of time domain offset information or frequency domain offset information for performing offset on the target reference signal pattern before the change corresponding to the first target frequency domain unit;
information of an additional reference signal pattern requested to be added;
at least one of: information of at least one pattern on which at least one of time domain or frequency domain offset needs to be performed in patterns except the basic reference signal pattern, or at least one of time domain offset information or frequency domain offset information for performing offset on the at least one pattern;
information of the first target frequency domain unit; and
information of a sub-band on which at least one of density or positions of reference signals needs to be changed in the first target frequency domain unit.

41. The method according to claim 31, wherein the method further comprises:
receiving, by the terminal device, a fifth message sent by a network device, wherein the fifth message is used for indicating at least one of:
a quantity of basic reference signal patterns available in a system;
at least one of positions or density of reference signals included in basic reference signal patterns available in a system;
a corresponding relationship between basic reference signal patterns available in a system and frequency domain units available in the system;
information of a target reference signal pattern corresponding to a second target frequency domain unit;
information of a second additional reference signal pattern; and
information of a first basic reference signal pattern; and
determining, by the terminal device, the N target frequency domain units for receiving the reference signals and the target reference signal pattern of the each target frequency domain unit in the N target frequency domain units, comprises:
determining, by the terminal device, the target reference signal pattern of the second target frequency domain unit in the N target frequency domain units according to the fifth message, or according to the fifth message and pre-configured information.

42. The method according to claim 41, wherein the method further comprises:
sending, by the terminal device, a second changing request to the network device, wherein the second changing request is used for changing the target reference signal pattern corresponding to the second target frequency domain unit.

43. The method according to claim 42, wherein the second changing request is used for indicating at least one of:
increasing or decreasing density of reference signals of the target reference signal pattern corresponding to the second target frequency domain unit;
at least one of density or positions of reference signals of the changed target reference signal pattern corresponding to the second target frequency domain unit;
information of a changed basic reference signal pattern corresponding to the second target frequency domain unit;
at least one of time domain offset information or frequency domain offset information for performing offset on a position of reference signals of the target reference signal pattern before the change corresponding to the second target frequency domain unit;
at least one of time domain offset information or frequency domain offset information for performing offset on the target reference signal pattern before the change corresponding to the second target frequency domain unit;
information of an additional reference signal pattern requested to be added or replaced;
at least one of: information of at least one pattern on which at least one of time domain or frequency domain offset needs to be performed in patterns except the basic reference signal pattern, or at least one of time domain offset information or frequency domain offset information for performing offset on the at least one pattern;
information of the second target frequency domain unit; and
information of a sub-band on which at least one of density or positions of reference signals needs to be changed in the second target frequency domain unit.

44. A network device comprising a processor and a transceiver; wherein,
the processor is used for determining N target frequency domain units for sending reference signals and a target reference signal pattern of each target frequency domain unit in the N target frequency domain units, wherein N is an integer greater than or equal to 1; and
the transceiver unit is used for sending the reference signals on the each target frequency domain unit according to the target reference signal pattern.

45-73. (canceled)

74. A terminal device comprising a processor and a transceiver; wherein,
the processor is used for determining N target frequency domain units for receiving reference signals and a target reference signal pattern of each target frequency domain unit in the N target frequency domain units, wherein N is an integer greater than or equal to 1; and
selecting a time-frequency resource for receiving the reference signals from the N target frequency domain units and time domain units corresponding to the N target frequency domain units; and
the transceiver is used for receiving the reference signals on the selected time-frequency resource.

75. The terminal device according to claim 74, wherein the selected time-frequency resource comprises in frequency domain all sub-bands for transmitting the reference signals in the N target frequency domain units.

76. The terminal device according to claim 74, wherein the selected time-frequency resource comprises in frequency domain all sub-bands for transmitting the reference signals in a part of the N target frequency domain units.

77. The terminal device according to claim 74, wherein the selected time-frequency resource comprises in frequency domain a part of sub-bands for transmitting the reference signals in at least one frequency domain unit of the N target frequency domain units.

78. The terminal device according to claim 74, wherein the transceiver is further used for receiving a first message sent by a network device, wherein the first message is used for indicating at least one of:
a quantity of frequency domain units in a system;
a sub-band occupied by each frequency domain unit;
a quantity N of the target frequency domain units; and
a sub-band occupied by each target frequency domain unit; and
the processor is further used for:
determining the N target frequency domain units according to the first message, or according to the first message and pre-configured information.

79. The terminal device according to claim 74, wherein the transceiver is further used for receiving a second message sent by a network device, wherein the second message is used for indicating that frequency domain units for sending the reference signals are M target frequency domain units, or used for indicating frequency domain units on which sending of the reference signals is stopped in the N target frequency domain units;
the processor is further used for selecting a time-frequency resource for receiving the reference signals from the M target frequency domain units and time domain units corresponding to the M target frequency domain units; and
the transceiver is further used for receiving the reference signals on the time-frequency resource selected from the M target frequency domain units and the corresponding time domain units.

80. The terminal device according to claim 74, wherein the transceiver is further used for:
receiving a third message sent by a network device, wherein the third message is used for indicating that frequency domain units for sending the reference signals are M target frequency domain units, or used for indicating M-N target frequency domain units newly added for sending the reference signals in the M target frequency domain units in addition to the N target frequency domain units;
the processor is further used for selecting a time-frequency resource for receiving the reference signals from the M target frequency domain units and time domain units corresponding to the M target frequency domain units; and
the transceiver is further used for receiving the reference signal on the time-frequency resource selected from the M target frequency domain units and the corresponding time domain units.

81. The terminal device according to claim 74, wherein the transceiver is further used for:
receiving a fourth message sent by a network device; wherein the fourth message is used for indicating at least one of:
a basic reference signal pattern is enabled on a first target frequency domain unit;
a quantity of basic reference signal patterns available in a system;
at least one of positions or density of reference signals included in basic reference signal patterns available in a system;
a corresponding relationship between basic reference signal patterns available in a system and frequency domain units available in the system; and
information of a target reference signal pattern corresponding to the first target frequency domain unit; and
the processor is further used for:
determining the target reference signal pattern of the first target frequency domain unit in the N target frequency domain units according to the fourth message, or according to the fourth message and pre-configured information.

82. The terminal device according to claim 74, wherein the transceiver is further used for:
sending a first changing request to a network device, wherein the first changing request is used for changing a target reference signal pattern corresponding to a first target frequency domain unit.

83. The terminal device according to claim 82, wherein the first changing request is used for indicating at least one of:
increasing or decreasing density of reference signals of the target reference signal pattern corresponding to the first target frequency domain unit;
at least one of density or positions of reference signals of a changed target reference signal pattern corresponding to the first target frequency domain unit;
information of a changed basic reference signal pattern corresponding to the first target frequency domain unit;
at least one of time domain offset information or frequency domain offset information for performing offset on the target reference signal pattern before the change corresponding to the first target frequency domain unit;
information of an additional reference signal pattern requested to be added;
at least one of: information of at least one pattern on which at least one of time domain or frequency domain offset needs to be performed in patterns except the basic reference signal pattern, or at least one of time domain offset information or frequency domain offset information for performing offset on the at least one pattern;
information of the first target frequency domain unit; and
information of a sub-band on which at least one of density or positions of reference signals needs to be changed in the first target frequency domain unit.

84. The terminal device according to claim 74, wherein the transceiver is further used for receiving a fifth message sent by a network device, wherein the fifth message is used for indicating at least one of:
a quantity of basic reference signal patterns available in a system;
at least one of positions or density of reference signals included in basic reference signal patterns available in a system;
a corresponding relationship between basic reference signal patterns available in s system and frequency domain units available in the system;
information of a target reference signal pattern corresponding to a second target frequency domain unit;
information of a second additional reference signal pattern; and
information of a first basic reference signal pattern; and
the processor is further used for:
determining the target reference signal pattern of the second target frequency domain unit in the N target frequency domain units according to the fifth message, or according to the fifth message and pre-configured information.

85. The terminal device according to claim 84, wherein the transceiver is further used for:
sending, by the terminal device, a second changing request to the network device, wherein the second changing request is used for changing the target reference signal pattern corresponding to the second target frequency domain unit.

86. The terminal device according to claim 85, wherein the second changing request is used for indicating at least one of:
increasing or decreasing density of reference signals of the target reference signal pattern corresponding to the second target frequency domain unit;
at least one of density or positions of reference signals of the changed target reference signal pattern corresponding to the second target frequency domain unit;
information of a changed basic reference signal pattern corresponding to the second target frequency domain unit;
at least one of time domain offset information or frequency domain offset information for performing offset on a position of the reference signals of the target reference signal pattern before the change corresponding to the second target frequency domain unit;
at least one of time domain offset information or frequency domain offset information for performing offset on the target reference signal pattern before the change corresponding to the second target frequency domain unit;
information of an additional reference signal pattern requested to be added or replaced;
at least one of: information of at least one pattern on which at least one of time domain or frequency domain offset needs to be performed in patterns except the basic reference signal pattern, or at least one of time domain offset information or frequency domain offset information for performing offset on the at least one pattern;
information of the second target frequency domain unit; and
information of a sub-band on which at least one of density or positions of reference signals needs to be changed in the second target frequency domain unit.
